(19) United States
(12) Patent Application Publication
(10) Pub. No.: US 2005/0068914 A1
(43) Pub. Date: Mar. 31, 2005

(54) Broadcasting and communication combining system based on Ethernet and method thereof

(76) Inventors: Kang-Bok Lee, Daejeon-city (KR); Heyung-Sub Lee, Daejeon-city (KR); Sang-Yeoun Lee, Daejeon-city (KR); Yong-Tae Kim, Daejeon-city (KR); Hyeong-Ho Lee, Daejeon-city (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/917,756

(22) Filed: Aug. 12, 2004

(30) Foreign Application Priority Data
Aug. 13, 2003 (KR) 10-2003-0056071

(51) Int. Cl. H04J 3/24

(52) U.S. Cl. 370/312

(57) ABSTRACT

Disclosed is a broadcasting and communication combining system based on an Ethernet and a method thereof for providing an Internet service and a multi-channel broadcasting service. The broadcasting and communication combining system and method based on an Ethernet uses Ethernet broadcasting frames on a data communication network to provide a wideband Internet service and a multi-channel digital broadcasting service. To support both Internet and broadcasting with one wavelength, the broadcasting traffic is converted to Ethernet data and multiplexed, and the multiplexed broadcasting traffic comprising the same band (one wavelength) of Internet data is transferred to a subscriber network. The subscriber terminal unit discriminates between Internet traffic and broadcasting traffic and outputs the Internet traffic and the broadcasting traffic to the final receiver.

### CROSS REFERENCE TO RELATED APPLICATION

This application claims priority to and the benefit of Korea Patent Application No. 2003-56071 filed on Aug. 13, 2003 in the Korean Intellectual Property Office, the entire content of which is incorporated herein by reference.

### BACKGROUND OF THE INVENTION

(a) Field of the Invention The present invention relates to a broadcasting and communication combining system and method based on the Ethernet for providing both an Internet service and a multi-channel broadcasting service.

2. (b) Description of the Related Art

General home users are provided with an Internet service and a VOD (Video On Demand) broadcasting service by their PC via an ISP (Internet Service Provider), and a variety of broadcasting services such as CATV broadcast, satellite broadcasting, etc. by their TV via ground wave and wire broadcasting networks.

Techniques for combining broadcasting and communication to provide both an Internet service and a broadcasting service through a TV have been actively studied. Methods for broadcasting/communication-combined services as suggested in the prior art include: a method of using the existing cable network, a method of using the overlay structure of optical signals in the existing communication line to provide broadcasting services, and a method of applying an RTP protocol to the IP Internet network to provide an integrated broadcasting service.

The method of using the existing cable network, the HFC (Hybrid Fiber Coaxial) network, supports a communication service on a broadcasting network, and the method of using the IP Internet network supports a broadcasting service through a data communication network.

Thus far, no method has been evidently suggested to combine a communication service and a broadcasting service through a single line to according to the same protocol to provide services to homes in an economical and efficient way. Thus there is a need for an effective method of providing all the services combining communication and broadcasting with a single line connected to homes.

FIG. 1 is a schematic of an HFC-based CATV network.

The CATV network comprises, as shown in FIG. 1, a program provider 101 for producing broadcasting programs and supplying them; a system operator 102 for switching channels between the programs received from the program provider and self-produced programs to provide a broadcasting service to subscribers; a CATV transport network 103 for transferring broadcasting signals to the system operator 102; and a CATV subscriber distribution network 104 for transferring the broadcasting signals from the system operator 102 to the subscribers.

The CATV subscriber distribution network 104 is called the HFC network because it uses an optical cable mixed with a coaxial cable connected from a distribution center 105 to the subscribers, providing both a cable TV service and an Internet service.

The system operator 102, which is a service provider, comprises a broadcasting section 106 for transferring received contents to the subscribers or inserting self-produced commercial messages or a caption into the contents, and sending them to the subscribers; and the distribution center 105 for transferring broadcasting signals to the subscribers.

In the transmission network, the subscriber distribution network 104 has ONU (Optical Network Unit) systems 108 for converting optical signals to electrical signals.

The broadcasting data converted to electrical signals by the ONU systems 108 transport services to the subscribers through a coaxial cable line. The CATV network also includes a repeater and a splitter used between each ONU system 108 and the subscriber according to the distance between the ONU system and the subscriber.

The HFC-based CATV network primarily provides a CATV broadcasting service and utilizes a part of the network bandwidth to combine an Internet service, a VOD service, and a telephone service.

The HFC-based CATV network is a technique exploited to combine a commercial broadcasting service with a communication service and provide both the two different services. The network is designed on the basis of the broadcasting network, so it has a lack of bandwidth for data communication to support the Internet service and a difficulty in providing the VOD broadcasting service due to a problem with the bandwidth for data communication.

Other standards for the HFC network are being established in an attempt to support the VOD broadcasting service. Once the standards are completed, installation of new service equipment is required for both the subscriber and the system operator.

The CATV transport network 103, which is located between the broadcasting program provider 101 providing broadcasting program contents and the system operator 102, uses an ATM network or a dedicated line. But, the CATV transport network 103 has low transmission efficiency with an ATM network and a high cost of channel service with a dedicated line.

FIG. 2 is a schematic of a digital broadcasting network of a PON (Passive Optical Network) digital broadcasting network using a WDM (Wavelength Division Multiplexing) method.

The PON digital broadcasting network using the WDM method comprises, as shown in FIG. 2, a broadcasting program provider 201, a CATV transport network 202, a system operator 203, a distribution center 204, and a PON subscriber network 205.

Unlike the HFC network in which optical signals are converted to electrical signals, the PON subscriber network 205 directly splits optical signals to increase the number of subscribers and transports the optical signals directly to the subscribers.

The PON digital broadcasting network using the WDM method, which is directed to reduction of the number of optical fibers used in the data communication network and enhancement of utility, applies the WDM technique to the PON subscriber network 205 to allocate optical signals of a different wavelength to the Internet service and the broadcasting service and to multiplex the allocated optical signals, thus combining communication with broadcasting.

Namely, the transmitter uses an OLT (Optical Line Terminal) 206 in the distribution center 204 to multiplex wavelengths for Internet and broadcasting services, and the receiver uses a WDM coupler 207 to provide services to the subscriber with the Internet and broadcasting wavelengths separated from one another.

The overlay structure using the PON network has recently been studied. It utilizes, for example, a wavelength of 1490 nm allocated to the downstream Internet service, a wavelength of 1310 nm allocated to the upstream Internet service, and a wavelength of 1550 nm allocated to the downstream broadcasting service.

The PON digital broadcasting system based on the WDM method uses an almost unlimited optical cable bandwidth for communication and broadcasting services without restriction of the number of channels. In addition, it can be is easily realized in a simple way.

Disadvantageously, the PON digital broadcasting system based on the WDM method still processes the broadcast requested by the subscriber such as a VOD broadcast as Internet data and uses a downstream wavelength of 1490 nm for Internet service, dividing broadcasting services into parts and requiring a separated operation of the receiver. Furthermore, it requires the use of expensive optical components due to the necessity of wavelength division and optical power amplification, which increases the economic burden and makes it more difficult to establish an economical network.

FIG. 3 is a hierarchical diagram of broadcasting data transmission using the CATV transport network (ATM transport network) of FIGS. 1 and 2.

Referring to FIG. 3, the ATM transport network 305 is located between a broadcasting program provider 301 and a system operator 302, and is responsible for transmission of broadcasting signals via an ATM edge switch 303 and a backbone ATM switch 304.

The ATM upper protocols are divided into two parts according to the system of the broadcasting program provider 301 that provides programs to the system operator 302.

The first part is line 1 on which MPEG-TS (Transport Stream) data are transferred directly on the ATM, and the second one is line 2 on which MPEG-TS data are transferred on the ATM through an IP.

The method of distributing MPEG-TS data to the ATM transport network on the two lines 1 and 2 deteriorates the transmission utility, because one MPEG-TS data set is are divided into a plurality of ATM cells.

FIG. 4 shows a mapping structure of MPEG data and ATM cells in the ATM transport network of FIG. 3.

The conversion between MPEG2 stream 401 and ATM cell 402 in the ATM transport network is illustrated in FIG. 4, where two MPEG-TS data sets are converted into one ATM AAL5 in transmission of MPEG-TSs using the ATM AAL5.

The MPEG2 stream 401 is converted to a 188-byte MPEG-TS 403. The MPEG-TS 403 is carried on an AAL1 or AAL5 404 and is separately transported on the payload of a 48-byte ATM frame.

In mapping the MPEG-TS 403 with a PDU (Packet Data Unit), two MPEG-TSs 403 are mapped to 8 ATM cells. This is applied to the VOD Spec 1.1 of the ATM Forum.

The main problems with AAL5 are that it has neither an extraction technique of time information nor a forward error correction function. But, the AAL5 has an advantage in that terminal user equipment equipped with AAL-5 for data and signal transmission can provide image service without additional expenses.

In mapping the MPEG-TS 403 with an AAL1 PDU, one MPEG-TS 403 is mapped to 4 ATM AAL1 cells. The main advantage of AAL1 over AAL5 is that it is defined for a real-time application. The AAL1 is however problematic in that it is applied only to a constant bit rate (CBR).

Hence, there is a disadvantage that a lot of overhead occurs because one 188-byte MPEG-TS 403 must be transmitted with a plurality of divided ATM cells.

FIG. 5 is a schematic of a transport network for Internet broadcasting and VOD broadcasting services according to an example of the prior art.

In particular, FIG. 5 illustrates the structure of a network for transmitting VOD and Internet broadcasting data to a subscriber 504 using an IP multicast in an Internet network comprising a router system.

A broadcasting program provider 501 sends broadcasting data to an edge router 502 having a system operator function through a bandwidth previously allocated by a backbone network 503 or a dedicated line (SONET, Giga Ethernet).

The subscriber network in which the edge router 502 having a system operator (SO) function that sends data to subscribers can be constructed in the form of a point-to-point or point-to-multipoint (PON network) network, which is required to support an IP multicast function.

To support the IP multicast function, the subscriber network constructed with the Ethernet alone is required to provide an IGMP (Internet Group Message Protocol) snooping function or a GMRP (GARP Multicast Registration Protocol) function.

FIG. 6 shows a frame structure of an IP Internet broadcasting network.

In the respective transport layers for providing a broadcasting service on an Internet network comprising a router system, as shown in FIG. 6, all edge routers 604 must support an IP multicast in the network connected to a broadcasting program provider 601 and a subscriber 602.

To transmit IP multicast traffic through an IP router backbone network 603, the edge router 604 sends the IP multicast traffic to other edge routers 604 through IP tunneling of a backbone router 605.

The IP tunneling is performing IP encapsulation of all the IP multicast traffic to enable IP unicast communication among the edge routers 604. The subscriber network must support the IP multicast so as to transmit the IP multicast traffic from the system operator to the subscriber.

For example, the subscriber switch of an FTTH (Fiber To The Home) EPON network or an FTTH metro Ethernet network comprises link layers, so each terminal performs IGMP snooping or GMRP to transmit the IP multicast traffic only to the corresponding ports admitted to a multicast group.

However, few switch chips or bridge chips provide an IP multicast support function, and the provision of this function in software increases a burden on the CPU.

As various types of communication and broadcasting media are being developed with an increased request for services for those media, many approaches have been exploited to use a single transmission line or a single receiver by combining a broadcasting service and a communication service, which are independently provided to subscribers through a separate transmission channel and a separate receiver in the conventional method.

It is, however, difficult to combine broadcasting and communication on a data communication network due to the characteristics of broadcasting data that achieve real-time transmission through RF modulation as CATV broadcast data and require a wideband. First of all, a broadcasting service for bidirectional communication such as VOD service is hard to provide on the conventional broadcasting network.

The above-suggested communication and broadcasting combining service method requires installation of high-priced new equipment.

As a result, a wideband bandwidth is required with the difficulty of providing real-time broadcasting data when the broadcasting service is provided without RF modulation at the data communication network. In addition, the HFC network has the difficulty of providing a VOD broadcasting service, which is conventionally provided on the data communication network.

Therefore, the home communication service is provided separately from home broadcasting in this age of combined communication and broadcasting services, so communication is realized by a subscriber network technique (xDSL or cable modem), broadcasting being realized by wire broadcast, ground wave broadcast, and satellite broadcast.

### SUMMARY OF THE INVENTION

It is an advantage of the present invention to combine a broadcasting service and a communication service by supporting a multi-channel broadcast service such as a CATV service, a VOD broadcast service, and an Internet broadcast service using an Ethernet-based transport network instead of the conventional broadcasting and communication networks that are independent of each other.

In one aspect of the present invention, there is provided a broadcasting and communication combining system based on an Ethernet, which system is for providing an Internet traffic and broadcasting data service to a receiver of a subscriber network through a transmission network, the broadcasting and communication combining system including: a broadcasting program provider for constructing Ethernet broadcasting frames from channel-specific broadcasting signals including a variable for determination of the type of broadcast and whether or not the signals are transferred, and sending the constructed Ethernet broadcasting frames; and a system operator for receiving the Ethernet broadcasting frames from the broadcasting program provider, selecting one of the Ethernet broadcasting frames requested by each subscriber, reconstructing the selected Ethernet broadcasting frame, multiplexing the reconstructed Ethernet broadcasting frame together with the Internet traffic, and sending the multiplexed Ethernet broadcasting frame with the Internet traffic to the subscriber network.

The transmission network includes: an edge switch for determining a priority of the Ethernet broadcasting frames and designating the Ethernet broadcasting frames as a virtual LAN (VLAN) group; and a backbone switch for performing a tunneling function.

When the broadcasting program provider provides a unidirectional CATV broadcasting service, the edge switch designates broadcasting contents provided from the broadcasting program provider to the system operator as one VLAN group and provides them to a plurality of the system operators, the system operator designating broadcasting contents provided through the edge switch as a second VLAN group or a specific Ethernet format and providing them to all the system operators.

The subscriber network includes a port for preliminarily allocating a bandwidth for broadcasting of as much as the number of broadcasting channels provided to the subscriber, and assigning the rest of the bandwidth as an Internet bandwidth for an Internet service.

When the broadcasting signal is a digital broadcasting signal other than a broadcasting signal (MPEG-TS: MPEG transport stream) by MPEG-2 coding, the broadcasting program provider maps the broadcasting signal and converts it to a channel-specific Ethernet broadcasting frame.

The broadcasting program provider includes: an encoder for converting a broadcasting stream to a broadcasting signal MPEG-TS when the broadcasting signal is analog; a buffer for storing the converted MPEG-TS from the encoder and a broadcasting stream input in an MPEG-TS form; and an Ethernet encapsulator for adding an Ethernet header for broadcast to the MPEG stream output from the buffer and sending the MPEG stream as an Ethernet broadcasting frame to the system operator.

The Ethernet header for broadcast of the Ethernet encapsulator includes channel information and information indicating that the MPEG stream is a broadcasting traffic.

The Ethernet encapsulator transmits at least one MPEG-TS on one Ethernet broadcasting frame according to the number of the MPEG-TSs stored in the buffer.

The Ethernet encapsulator determines the number of MPEG-TSs transferable on the Ethernet broadcasting frame by a maximum transmission unit provided in the transmission network.

The channel-specific Ethernet broadcasting frame is constructed so as to carry broadcasting data on the Ethernet broadcasting frame, or to maintain a TCP/IP layer for a VOD (Video On Demand) broadcasting service or a bidirectional broadcasting service requested by the receiver of the subscriber.

The Ethernet broadcasting frame includes: a destination address for making the Ethernet broadcasting frame arrive at the corresponding system operator from the broadcasting program provider; a type field for designating an ID by the type of broadcast so as to discriminate the type of broadcast; and a VLAN field for determining a priority of the broadcasting signals or constructing VLAN tunneling, and discriminating the broadcasting data.

The destination address of the Ethernet broadcasting frame comprises a unicast or a multicast.

The system operator includes: a distribution center for multiplexing all the Ethernet broadcasting frames received from the broadcasting program provider through a backbone network, or multiplexing only the Ethernet broadcasting frames requested by the subscriber network.

The distribution center includes: a transmission block for adding a defined Ethernet header negotiated with the subscriber network to the broadcasting data in the form of the Ethernet broadcasting frame, or converting the broadcasting data in the form of the Ethernet broadcasting frame.

The transmission block includes: a broadcast classification switch for analyzing the Ethernet broadcasting frame to determine the type of broadcast as a CATV broadcast, VOD broadcast, or Internet broadcast, and switching the Ethernet broadcasting frame to a corresponding channel by the respective broadcasting services; a channel-specific Ethernet encapsulator for discriminating the classified Ethernet broadcasting frames of the broadcast classification switch according to the number of broadcasts and the broadcasting program provider, allocating broadcasting-service-specific channels to the Ethernet broadcasting frames, and adding an Ethernet header to the Ethernet broadcasting frames or converting the Ethernet broadcasting frames; a multiplexer for multiplexing the broadcasting data Ethernet-header-added or converted by the Ethernet encapsulator; and an Ethernet switch for switching and sending the multiplexed broadcasting data of the multiplexer together with the Internet traffic to each subscriber network.

The channel-specific Ethernet encapsulator adds a factor to the Ethernet header, the factor being used for discriminating between the Internet traffic and the broadcasting data in the subscriber network.

For providing a unidirectional broadcasting service such as a CATV broadcast and Internet broadcast, the factor added to the Ethernet header includes a multicast address for discriminating the broadcasting signals, a VLAN field for allocating a priority of the broadcasting signals or constructing VLAN tunneling, and a type field for discriminating the type of the broadcasting signals and channels, the Ethernet broadcasting frame having a payload part thereof being constructed as an MPEG-TS.

For providing a bidirectional broadcasting service such as VOD broadcast, the factor added to the Ethernet header includes a multicast address for discriminating the broadcasting signals, a VLAN field for allocating a priority of the broadcasting signals or constructing VLAN tunneling, and a type field for discriminating the type of the broadcasting signals and channels, the Ethernet broadcasting frame having a payload part thereof being constructed as an IP packet.

The multicast address for the broadcasting data includes a specific address not used in common.

The channel-specific Ethernet encapsulator adds a corresponding Ethernet header to the Ethernet broadcasting frames received in the form of the broadcasting signal (MPEG-TS), and converts the Ethernet broadcasting frames not received in the form of the broadcasting signal into an Ethernet header provided on the subscriber network.

The receiver of the subscriber network includes: an Ethernet broadcasting frame detector for checking the received data from the system operator and discriminating between Internet traffic and broadcasting data; a data frame processor for receiving the discriminated Internet traffic from the Ethernet broadcasting frame detector and sending it to a subscriber Internet service receiver; and a broadcasting signal frame processor for receiving the discriminated broadcasting data from the Ethernet broadcasting frame detector and Internet traffic sent to a set-top box, and processing the broadcasting data and the Internet traffic to be displayed on a subscriber TV.

The broadcasting signal frame processor provides the broadcasting data to the subscriber TV by sending only broadcasting channels of the broadcasting signals requested by the set-top box to the set-top box, and sends the Internet traffic other than the broadcasting signals to the set-top box.

The Ethernet broadcasting frame detector filters the Ethernet broadcasting frame and sends the Internet traffic and the broadcasting data to the broadcasting signal frame processor, the Internet traffic including an Ethernet address assigned to the set-top box.

In another aspect of the present invention, there is provided a broadcasting and communication combining method based on an Ethernet, which method is for providing an Internet traffic and broadcasting data service to a receiver of a subscriber network through a transmission network between a broadcasting program provider and a system operator, the broadcasting and communication combining method including: (a) the broadcasting program provider constructing Ethernet broadcasting frames from channel-specific broadcasting signals including a variable for determination of the type of broadcast and whether or not the signals are transferred, and sending the constructed Ethernet broadcasting frames to the system operator through the transmission network; (b) the system operator reconstructing the received Ethernet broadcasting frames of the step (a) by adding an Ethernet header used for determination of whether or not the broadcasting signals are transferred and discrimination between the Internet traffic and the broadcasting data; and (c) the system operator selecting an Ethernet broadcasting frame requested by each subscriber among the reconstructed Ethernet broadcasting frames of the step (b), multiplexing the selected Ethernet broadcasting frame together with the Internet traffic, and sending the multiplexed Ethernet broadcasting frame with the Internet traffic to the subscriber network.

The step (c) of receiving data by the subscriber network includes preliminarily allocating a broadcasting bandwidth of as much as the number of broadcasting channels provided to the subscriber, and assigning the rest of the bandwidth as an Internet bandwidth for an Internet service.

The step (a) of constructing the Ethernet broadcasting frames includes: (i) converting an analog broadcasting stream into a broadcasting signal (MPEG-TS), storing the converted broadcasting stream, and storing the broadcasting stream input in a MPEG-TS form without conversion; (ii) adding a broadcasting Ethernet header to the MPEG-TS type broadcasting stream stored in the step (i) to construct an Ethernet broadcasting frame, and sending the constructed Ethernet broadcasting frame to the system operator.

The step (ii) includes sending at least one MPEG-TS on one Ethernet broadcasting frame according to the number of the MPEG-TSs stored in the step (ii).

The step (a) of constructing an Ethernet broadcasting frame includes constructing the Ethernet broadcasting frame so as to carry broadcasting data on the Ethernet broadcasting frame and to maintain a TCP/IP layer for bidirectional broadcasting data requested by the receiver of the subscriber.

The step (a) of constructing an Ethernet broadcasting frame includes constructing the Ethernet broadcasting frame so as to include: a destination address for making the Ethernet broadcasting frame arrive at the corresponding system operator from the broadcasting program provider; a type field for discriminating the type of broadcast; and a VLAN field for determining a priority of the broadcasting signals or constructing VLAN tunneling, and discriminating the broadcasting data.

The step (b) includes: (i) analyzing the Ethernet broadcasting frame to determine the type of broadcast as a CATV broadcast, VOD broadcast, or Internet broadcast, and switching the Ethernet broadcasting frame to a corresponding channel by the respective broadcasting services; (ii) discriminating the classified Ethernet broadcasting frames of the step (i) according to the number of broadcasts and a broadcasting program provider, allocating broadcasting-service-specific channels to the Ethernet broadcasting frames, and adding an Ethernet header to the Ethernet broadcasting frames or converting the Ethernet broadcasting frames; and (iii) multiplexing the broadcasting data Ethernet-header-added or converted, and switching and sending the multiplexed broadcasting data together with the Internet traffic to each subscriber network.

The Ethernet header of the step (ii) is for providing a unidirectional broadcasting service such as a CATV broadcast and Internet broadcast, the Ethernet header including a multicast address for discriminating the broadcasting signals, a VLAN field for allocating a priority of the broadcasting signals or constructing VLAN tunneling, and a type field for discriminating the type of the broadcasting signals and channels, the Ethernet broadcasting frame having a payload part thereof being constructed as an MPEG-TS.

The Ethernet header of the step (ii) is for providing a bidirectional broadcasting service such as a VOD broadcast, the Ethernet header including a multicast address for discriminating the broadcasting signals, a VLAN field for allocating a priority of the broadcasting signals or constructing VLAN tunneling, and a type field for discriminating the type of the broadcasting signals and channels, the Ethernet broadcasting frame having a payload part thereof being constructed as an IP packet.

The step (ii) includes: adding a corresponding Ethernet header to the Ethernet broadcasting frames received in the form of the broadcasting signal (MPEG-TS); and converting the Ethernet broadcasting frames not received in the form of the broadcasting signal into an Ethernet header provided on the subscriber network.

The step (c) of the subscriber network receiving the Ethernet broadcasting frames includes: (i) checking the received data from the system operator and discriminating between the Internet traffic and the broadcasting data and sending the Internet traffic to a subscriber Internet service receiver; and (ii) outputting the broadcasting data among the discriminated data of the step (i) and Internet traffic transferred to a set-top box, to be displayed on a subscriber TV.

### BRIEF DESCRIPTION OF THE DRAWINGS

The accompanying drawings, which are incorporated in and constitute a part of the specification, illustrate an embodiment of the invention, and, together with the description, serve to explain the principles of the invention:

FIG. 1 is a schematic of an HFC-based cable TV network;

FIG. 2 is a schematic of a PON digital broadcasting network based on a WDM system;

FIG. 3 is a hierarchical diagram of broadcasting data transmission using the CATV transport network (ATM transport network) of FIGS. 1 and 2;

FIG. 4 shows a mapping structure of MPEG data and ATM cells in the ATM transport network of FIG. 3;

FIG. 5 is a schematic of a transport network for Internet broadcasting and VOD broadcasting services according to an example of the prior art;

FIG. 6 shows a frame structure of an IP Internet broadcasting network;

FIG. 7 is a schematic of a broadcasting network for an Ethernet-based digital broadcasting service applied to the present invention;

FIG. 8 is a schematic of an Ethernet-based Internet and CATV broadcasting transport network applied to the present invention;

FIG. 9 is a hierarchical diagram of an Ethernet-based broadcasting and communication combining system according to an embodiment of the present invention;

FIG. 10 shows the process of forming an Ethernet broadcasting frame for the Ethernet-based broadcasting and communication combining system according to the embodiment of the present invention;

FIG. 11 is a schematic of a transmission block of the broadcasting program provider of FIG. 9;

FIG. 12 shows the encapsulation process of the Ethernet encapsulator of FIG. 11;

FIG. 13 is a schematic of an Ethernet broadcasting frame communicated between the broadcasting program provider and the system operator of FIG. 9;

FIG. 14 is a flow chart of input/output broadcasting streams of the system operator of FIG. 9;

FIG. 15 is a schematic of a transmission block of the distribution system in the system operator of FIG. 9;

FIG. 16 is a schematic of an Ethernet broadcasting frame for a unidirectional broadcasting service in the distribution system of the system operator of FIG. 9;

FIG. 17 is a schematic of an Ethernet broadcasting frame for a bidirectional broadcasting service in the distribution system of the system operator of FIG. 9; and

FIG. 18 is a schematic of a receiver of the subscriber network of present invention.

### DETAILED DESCRIPTION OF THE PREFERRED EMBODIMENTS

In the following detailed description, only the preferred embodiment of the invention has been shown and described, simply by way of illustration of the best mode contemplated by the inventor(s) of carrying out the invention. As will be realized, the invention is capable of modification in various obvious respects, all without departing from the invention. Accordingly, the drawings and description are to be regarded as illustrative in nature, and not restrictive.

The present invention is directed to an Ethernet-based broadcasting and communication combining system and a method thereof, that is for supporting a unidirectional multi-channel CATV broadcasting service and a communication service using a single line in an Ethernet-based transport network instead of a separate broadcasting line, to provide an integrated service of broadcasting and communication.

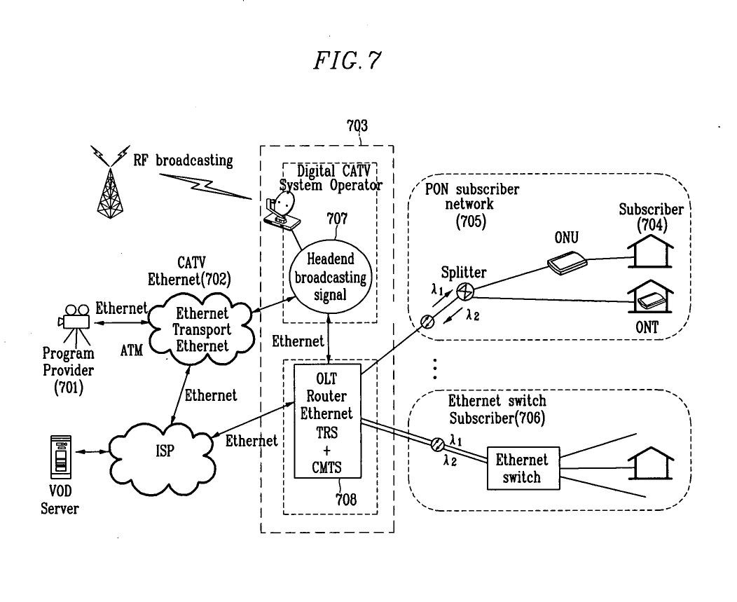

FIG. 7 is a schematic of a broadcasting network for an Ethernet-based digital broadcasting service applied to the present invention.

The Ethernet-based Internet and CATV broadcasting transport network for in-band broadcasting applied to the present invention comprises, as shown in FIG. 7, an Ethernet-based transport network 702, a system operator 703, and a subscriber distribution network for data transfer from an OLT system 709 in the system operator 703 to an individual subscriber 704.

The Ethernet-based transport network 702 for in-band broadcasting enables a broadcasting program provider 701 for ground wave broadcasting, satellite broadcasting, Internet broadcasting, etc. to transfer broadcasting data to the system operator 703.

The system operator 703 comprises a broadcast processing system 707 for inserting a self-produced commercial message or a caption to organize broadcasting signals, and the OLT system 709 for processing broadcasting data received from the broadcasting program provider 701 and transferring signals in a distribution center 708 to the subscriber 704.

The subscriber distribution network includes an EPON (Ethernet PON) network 705 and a metro Ethernet network 706. The equipment used for the subscriber distribution network comprises Ethernet-based equipment that is constructed to support any kind of Ethernet-based network by the subscriber network. Hence, the entire broadcasting network can be constructed simply with an Ethernet system, which is a most economical data communication network.

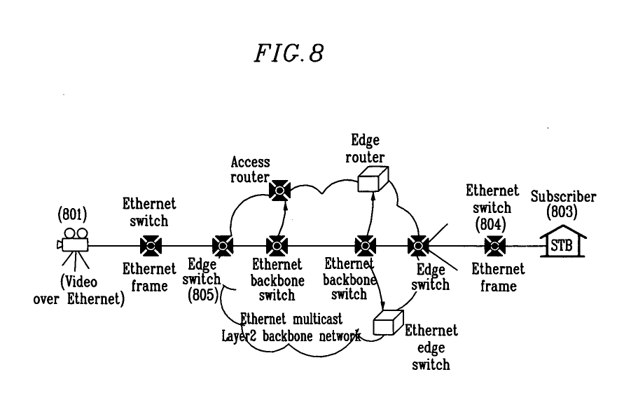

FIG. 8 is a schematic of an Ethernet-based Internet and CATV broadcasting transport network applied to the present invention.

The Ethernet-based Internet and CATV broadcasting transport network comprises, as shown in FIG. 8, a dedicated line and a high-speed Ethernet switch between a broadcasting program provider 801 and a system operator 802, and an EPON or Ethernet switch network 804 between the system operator 802 and a subscriber 803.

In case of the broadcasting program provider 801 providing a unidirectional CATV service to multiple system operators 802, an Ethernet edge switch system 805 designates the broadcasting contents as one VLAN (Virtual LAN) group so that the broadcasting contents are provided to the system operators 802.

Each system operator 802 allocates the contents from the broadcasting program provider 801 to another VLAN group or a specific Ethernet format and provides them to all the subscribers 803 via the subscriber network switch 804.

The broadcasting transport network of this structure enables a transmission of broadcasting traffic, which are basically allocated to the Ethernet, to each subscriber 803, and all the networks comprises only a lower Ethernet MAC layer for data transmission, realizing a high-speed switching.

In addition, the service of the IP layer requesting a VOD broadcasting service or a bidirectional service is provided using an edge router system instead of the Ethernet switch system at the edge, as shown in FIG. 6, and an Ethernet-based network structure can also be realized in the backbone network.

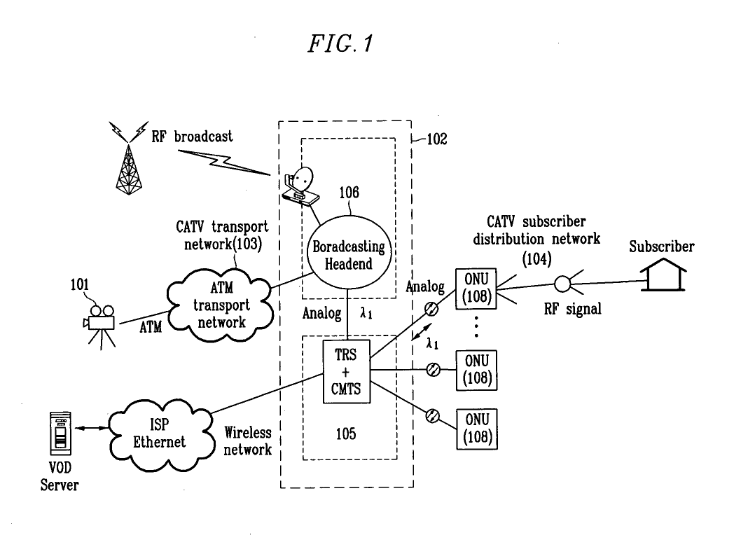

First, the Ethernet-based broadcasting and communication combining system according to a first embodiment of the present invention is described in detail with reference to FIG. 1.

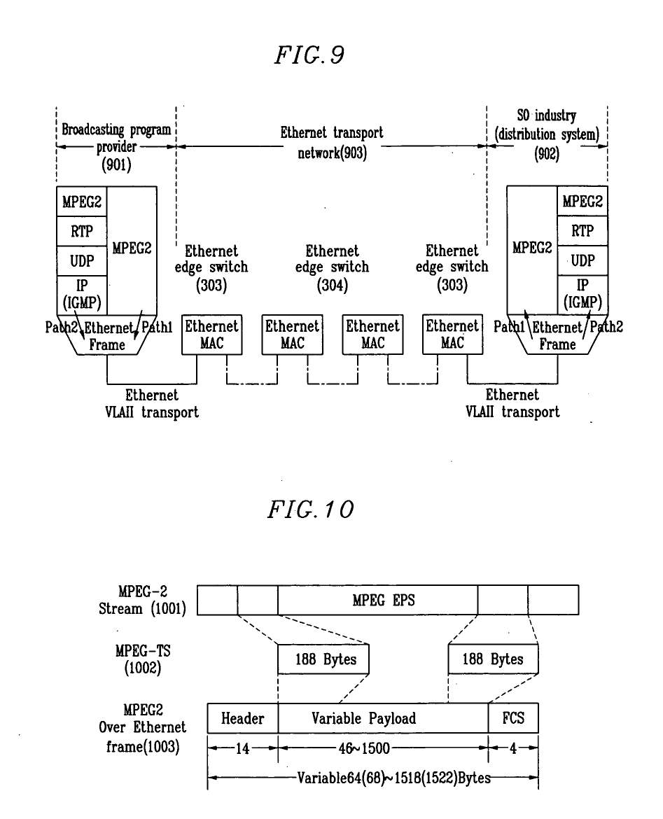

FIG. 9 is a hierarchical diagram of the Ethernet-based broadcasting and communication combining system according to an embodiment of the present invention.

The Ethernet-based broadcasting and communication combining system according to the embodiment of the present invention comprises, as shown in FIG. 9, a broadcasting program provider 901 for producing broadcasting signals, a system operator 902 for transferring the broadcasting signals to the subscribers, and a subscriber receiver for receiving the broadcasting signals.

Here, an Ethernet transport network 903 between the broadcasting program provider 901 and the system operator 902 comprises an edge switch 904 for determining priority and performing a VLAN function, and a backbone switch 905 for performing a VLAN tunneling function.

The transport network of the subscriber network comprises an Ethernet switch network to process an Ethernet broadcasting frame.

The broadcasting program provider 901 comprises a transmission block 1100 for constructing the Ethernet broadcasting frames from channel-specific broadcasting signals containing a variable indicating the type of broadcast and whether or not the signals are transferred, and sending the constructed Ethernet broadcasting frames to the system operator 902.

The system operator 902 comprises a distribution center for receiving the Ethernet broadcasting frames, selecting an Ethernet broadcasting frame requested by each subscriber, multiplexing the selected Ethernet broadcasting frame together with an Internet traffic, and sending it to the subscriber network.

In providing broadcasting data from the broadcasting program provider 901, the unidirectional broadcasting service is provided through a path 1 with MPEG-TS carried on the Ethernet broadcasting frame, and the VOD broadcasting service on the existing Internet or the bidirectional broadcasting service requested for a set-top box (STB) is provided through a path 2 with the TCP/IP layer maintained.

The broadcasting data service such as the VOD service directly provided from the system operator 902 to the subscriber is provided through either of the paths 1 and 2 with MPEG-TS carried on the Ethernet broadcasting frame.

In this way, the Ethernet-based broadcasting and communication combining system according to the embodiment of the present invention can efficiently provide both the broadcasting data service with a general Internet traffic and the unidirectional broadcasting data service such as a CATV service to the subscribers.

The operation of the Ethernet-based broadcasting and communication combining system according to the embodiment of the present invention is described as follows with reference to the accompanying drawings.

FIG. 10 shows the process of forming an Ethernet broadcasting frame for the Ethernet-based broadcasting and communication combining system according to the embodiment of the present invention.

Referring to FIG. 10, an MPEG stream 1001 is converted to a 188-byte MPEG-TS 1002 and carried on an Ethernet broadcasting frame 1003, before it is sent to the Ethernet transport network 903.

Here, one Ethernet broadcasting frame 1003 carries multiple MPEG-TS data 1002 according to the number of the MPEG-TSs 1002 received by the system operator 902.

The number of MPEG-TSs 1002 transferable on one Ethernet broadcasting frame 1003 is dependent upon the MTU (Maximum Transmission Unit) provided by the Ethernet transport network 903.

For example, in FIG. 10, multiple MPEG-TSs 1002 are carried in a 1500-byte Ethernet broadcasting frame. Unlike the conventional ATM transmission system that carries an MPEG-TS on multiple ATM cells, multiple MPEG-TSs are carried on a single Ethernet broadcasting frame to enhance the transmission efficiency.

This method of transferring multiple MPEG-TSs on one Ethernet broadcasting frame is asynchronous and variable in size from 64 bytes to 1516 bytes, so as to easily transfer MPEG-TSs occurring discontinuously.

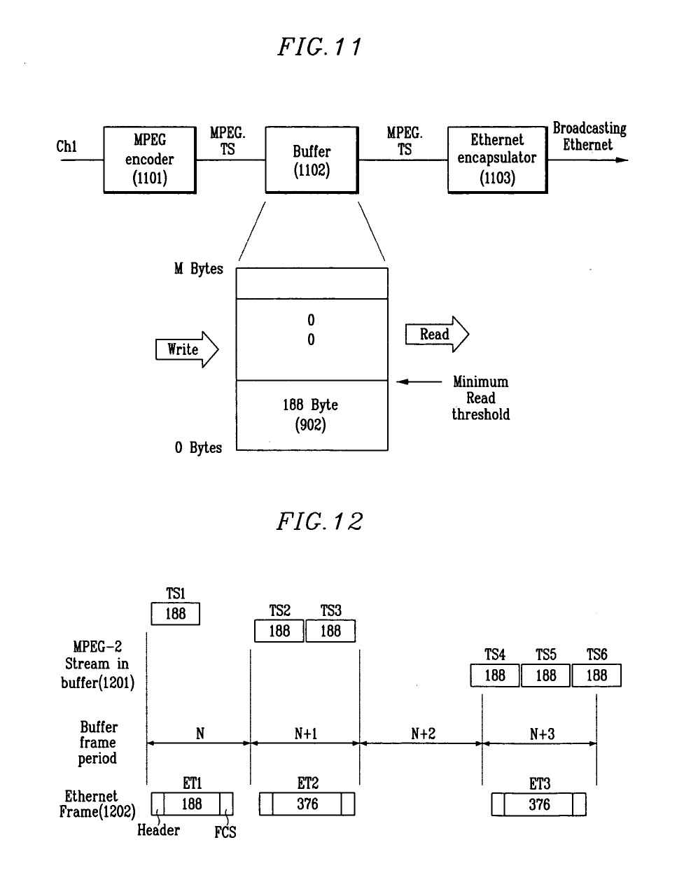

FIG. 11 is a schematic of a transmission block of the broadcasting program provider of FIG. 9.

Referring to FIG. 11, the transmission block 1100 comprises, if not specifically limited to, an encoder 1101, a buffer 1102, and an encapsulator 1103.

The encoder 1101 converts an analog broadcasting stream into an MPEG-TS and stores the converted MPEG-TS in a 188 byte unit 1104. The buffer 1102 stores the converted MPEG-TS from the encoder 1101. The MPEG-TS type broadcasting stream is directly stored in the buffer 1102 without passing through the encoder 1101.

The Ethernet encapsulator 1103 adds a broadcasting Ethernet header to the MPEG stream output from the buffer 1102 and sends the MPEG stream carried on the Ethernet broadcasting frame to the system operator 902.

The Ethernet encapsulator 1103 inserts channel information and information indicating broadcasting traffic into the Ethernet header.

When the broadcasting signal is a digital broadcasting signal other than the MPEG-TS generated by MPEG-2 coding, the transmission block 1100 maps the broadcasting signal and converts it into a channel-specific Ethernet broadcasting frame.

FIG. 12 shows the encapsulation process of the Ethernet encapsulator of FIG. 11.

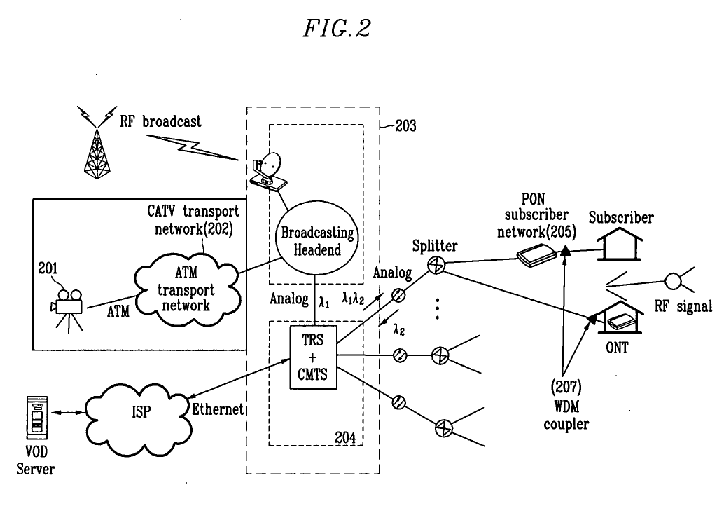

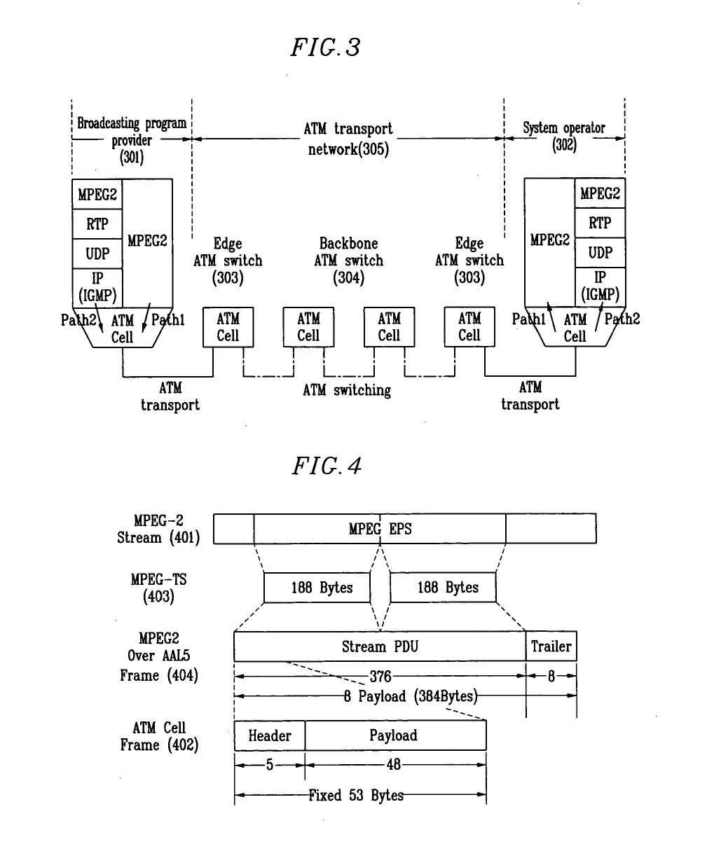

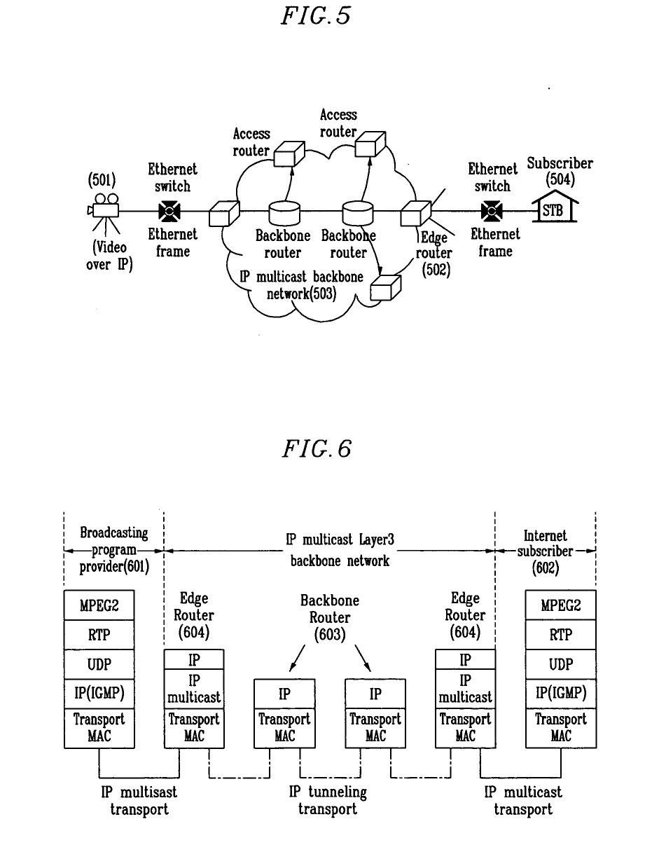

Namely, FIG. 2 shows the process in which an MPEG-TS 1201 in the buffer 1102 is inserted into Ethernet broadcasting frames 1202.

When the Ethernet broadcasting frames 1202 are generated at predetermined intervals, multiple MPEG-TSs 1201 are carried in one Ethernet broadcasting frame 1202 according to the number of the MPEG-TSs 1201 stored in the buffer 1102, or only one MPEG-TS 1201 is transferred on one Ethernet broadcasting frame 1202 according to the situation in the buffer 1102.

Therefore, the Ethernet-based broadcasting and communication combining system according to the embodiment of the present invention generates Ethernet broadcasting frames only in the presence of MPEG-TSs, so it can use the bandwidth of the Ethernet transport network 903 effectively.

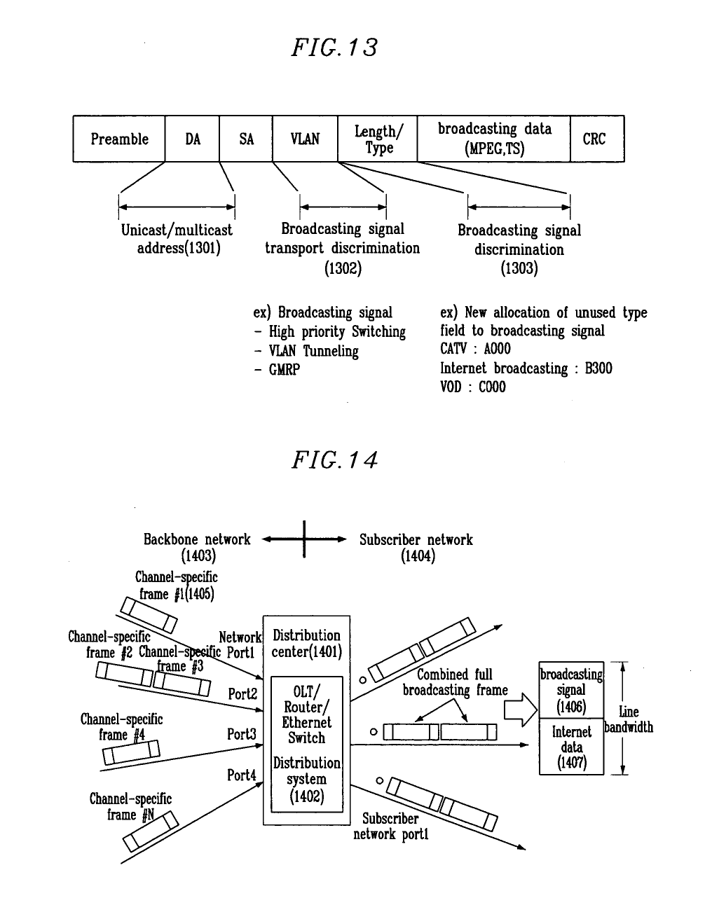

FIG. 13 is a schematic of an Ethernet broadcasting frame communicated between the broadcasting program provider and the system operator of FIG. 9.

The Ethernet broadcasting frame comprises, as shown in FIG. 13, a destination address 1301 to make the Ethernet broadcasting frame arrive at a corresponding system operator from each of the broadcasting program providers, a VLAN field 1302, and a type field 1303.

The destination address 1301 of the Ethernet broadcasting frame can include a unicast or a multicast according to the situation of the Ethernet transport network.

The VLAN field 1302, which is used to allocate a priority for guaranteeing the QoS of broadcasting signals or construct VLAN tunneling in the Ethernet transport network, can be used to discriminate broadcasting data.

The allocation of a priority for guaranteeing the QoS of broadcasting signals can also be achieved with the type field 1303 in the Ethernet broadcasting frame level to classify the broadcasting signals and transfer a selected broadcasting signal in priority.

The type field 1303 designates the ID of the broadcasting signals by the type of broadcast so as to discriminate the types of the broadcasting signals in the Ethernet broadcasting frame, because the type of broadcast varies depending on the characteristic of the broadcasting program provider.

The Ethernet frames received by the system operator can be classified into different Ethernet broadcasting frame groups by the characteristic of the broadcast according to the type field 1303.

Therefore, the Ethernet-based broadcasting and communication combining system according to the embodiment of the present invention guarantees the QoS of broadcasting signals in the MAC level without using the protocol of the upper layer to achieve a reliable transmission of the broadcasting signals.

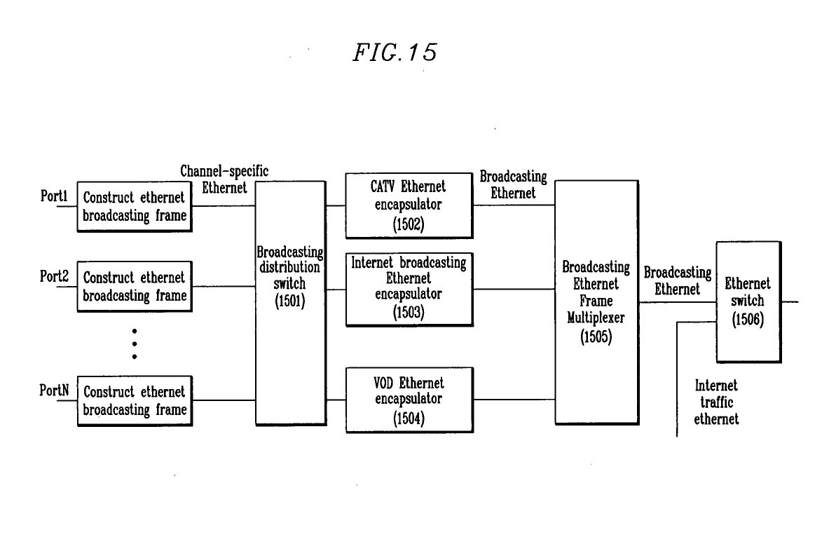

FIG. 14 is a flow chart of input/output broadcasting streams of the system operator of FIG. 9.

Referring to FIG. 14, a distribution system 1402 present in a distribution center 1401 of the system operator may include an OLT system of the PON network, a router system of the IP network, an Ethernet switch system of the metro Ethernet network, etc.

The broadcasting data, if transferred from every broadcasting program provider in the form of Ethernet broadcasting frames 1405 as illustrated in FIG. 13, are fed into the distribution system 1402 via a backbone network 1403.

The Ethernet broadcasting frames 1405 received by the distribution system 1402 are all multiplexed and sent to the port of a subscriber network 1404. Here, all the Ethernet broadcasting frames are multiplexed, or only a part of the Ethernet broadcasting frames as requested by the subscriber network 1404 are multiplexed.

The multiplexed Ethernet broadcasting frames are converted to a defined Ethernet header as negotiated between the distribution system and the subscriber network and sent to each subscriber, or they are directly sent to the individual subscribers without a separate conversion step.

The port of each subscriber network 1404 preliminarily allocates a broadcasting bandwidth 1406 of as much as the number of broadcasting channels provided to the subscriber, and assigns the rest of the bandwidth as an Internet bandwidth 1407 for an Internet service.

FIG. 15 is a schematic of a transmission block 1500 of the distribution system in the system operator of FIG. 9.

Referring to FIG. 15, the transmission block 1500 of the distribution system adds an Ethernet header that is adequate for the characteristic of each broadcast to the Ethernet broadcasting streams fed into the distribution center, or converts the Ethernet broadcasting streams into such an Ethernet header.

The transmission block 1500 comprises, if not specifically limited to, a broadcast classification switch 1501, channel-specific Ethernet encapsulators 1502, 1503, and 1504, a multiplexer 1505, and an Ethernet switch 1506.

The broadcast classification switch 1501 analyzes the Ethernet broadcasting frames to determine the type of broadcast as a CATV broadcast, VOD broadcast, or Internet broadcast, and switches the Ethernet broadcasting frames to a corresponding service-specific channel.

The channel-specific Ethernet encapsulators 1502, 1503, and 1504 discriminate the Ethernet broadcasting frames of the broadcast classification switch 1501 by the number of broadcasts and the broadcasting program provider, allocate channels by the type of broadcast such as CATV broadcasting, Internet broadcasting, and VOD broadcasting, and add an Ethernet header to the Ethernet broadcasting frames or convert the Ethernet broadcasting frames to an Ethernet header.

The multiplexer 1505 multiplexes the header-added or converted broadcasting data from the channel-specific Ethernet encapsulators 1502, 1503, and 1504, and the Ethernet switch 1506 switches the multiplexed broadcasting data of the multiplexer 1505 together with Internet traffic and sends them to each subscriber network.

The operation of the transmission block 1500 of the distribution system is described as follows.

The broadcast distribution switch 1501 analyzes the type field of the Ethernet broadcasting frames from the broadcasting program providers to classify the Ethernet broadcasting frames according to the type of broadcast such as CATV broadcasting, VOD broadcasting, and Internet broadcasting, and switches the classified Ethernet broadcasting frames to the Ethernet encapsulators 1503 and 1504.

Each of the Ethernet encapsulators 1501, 1502, and 1503 discriminates the classified broadcasting frames based on the number of broadcasts and the address of the broadcasting program provider, allocates channels by the broadcasting service, and adds an Ethernet header to the Ethernet broadcasting frames or converts the Ethernet broadcasting frames to an Ethernet header.

Upon receiving contents from the broadcasting program provider in the form of MPEG-TS, the Ethernet encapsulators 1501, 1502, and 1503 add the corresponding Ethernet header. Otherwise, the Ethernet encapsulators 1501, 1502, and 1503 convert the contents into a corresponding Ethernet header.

The Ethernet frame multiplexer 1505 multiplexes the header-added or converted broadcasting data of the Ethernet encapsulators 1501, 1502, and 1503. The Ethernet switch 1506 switches the multiplexed broadcasting Ethernet frames together with Ethernet frames for Internet traffic input through another line of the network and sends them to each subscriber.

The transmission block of the distribution system adds a factor for the receiver of the subscriber to discriminate between the Internet traffic and the broadcasting traffic.

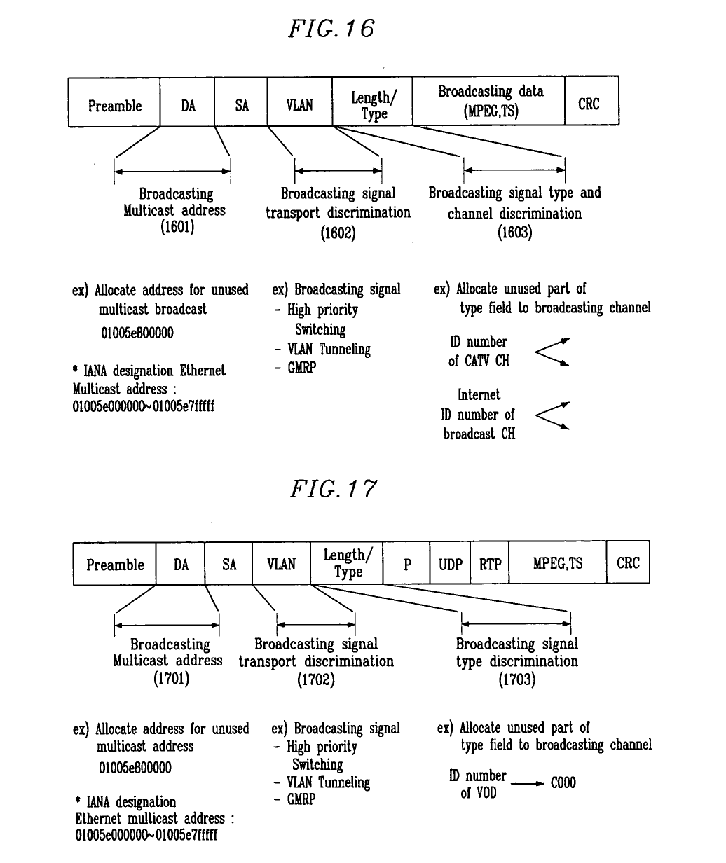

FIG. 16 is a schematic of an Ethernet broadcasting frame for a unidirectional broadcasting service in the distribution system of the system operator of FIG. 9.

The Ethernet broadcasting frame for providing a unidirectional broadcasting service such as CATV broadcasting and Internet broadcasting is used as a factor for discriminating between the Internet traffic and the broadcasting traffic, and comprises, as shown in FIG. 16, a multicast address 1601 at the Ethernet header, a VLAN field 1602, and a type field 1603.

To guarantee the QoS by active switching and high priority switching of broadcasting data at the subscriber network, the specific multicast address 1601 not commonly or generally used is allocated to the broadcasting data.

Hence, the subscriber network uses the multicast address to discriminate broadcasting signals and to perform high priority switching for guaranteeing QoS.

Like the Ethernet broadcasting frame as shown in FIG. 13, the VLAN field 1602 is used to allocate a priority or to construct VLAN tunneling. To discriminate the subscriber-specific requested broadcasting channels, the type field 1603 designates a channel ID by the broadcasting channel to discriminate the type of the broadcasting signals and channels.

By using the type field 1603, the Ethernet broadcasting frames fed into the subscriber network select the channel of each broadcast for reception of services. The type field 1603 uses a separate value to specify that the Ethernet broadcasting frame is a broadcasting frame, and inserts a different value for a broadcasting channel and an Internet broadcasting channel, so the broadcasting channel can be discriminated according to the Ethernet broadcasting frames.

FIG. 17 is a schematic of an Ethernet broadcasting frame for a bidirectional broadcasting service in the distribution system of the system operator of FIG. 9.

The Ethernet frame for a bidirectional broadcasting service such as a VOD broadcasting service comprises, as shown in FIG. 16, a multicast address 1701 defined in the Ethernet header, a VLAN field 1702, and a type field 1703. The payload part of the Ethernet broadcasting frame is not an MPEG-TS, but rather is an IP packet.

The multicast address 1701 and the VLAN field 1702 have the same function as those in the Ethernet broadcasting frame for a unidirectional broadcasting service. For a VOD broadcasting service, the Ethernet broadcasting frame, which is a unicast type frame requested by each subscriber, does not discriminate channels but has a network ID, i.e., the ID address value.

The type field 1703, which is not required to discriminate channels, has a single type field value indicating a VOD broadcasting service.

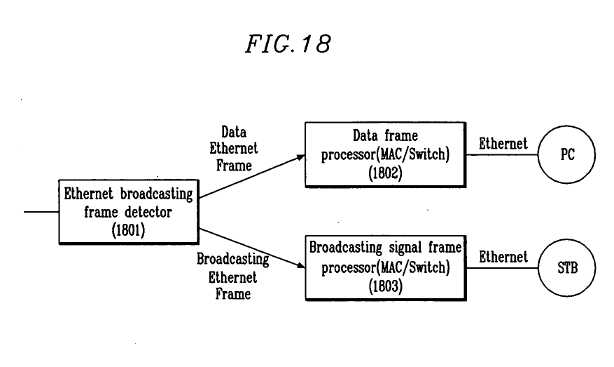

FIG. 18 is a schematic of the receiver of the subscriber network of present invention.

Referring to FIG. 18, the receiver of the subscriber network comprises, if not specifically limited to, an Ethernet broadcasting frame detector 1801, a data frame processor 1802, and a broadcasting signal frame processor 1803.

The Ethernet broadcasting frame detector 1801 checks the received data from the system operator to discriminate between Internet traffic and broadcasting data. The data frame processor 1802 receives the Internet traffic from the Ethernet broadcasting frame detector 1801 and sends it to the Internet service receiver of the subscriber, i.e., the subscriber PC.

The broadcasting signal frame processor 1803 receives the broadcasting data from the Ethernet broadcasting frame detector 1801 and the Internet traffic from the STB and outputs them to be displayed on the subscriber's TV.

Here, the method of the Ethernet broadcasting frame detector 1801 discriminating between the Internet traffic and the broadcasting data transferred to the set-top box is the reverse of the classification method applied to the Ethernet broadcasting frames in the distribution system as described above.

Namely, the Ethernet broadcasting frame detector 1801 sends the Internet traffic (including the VOD service, classified by IP address) using the Ethernet header of the Ethernet broadcasting frames, and transmits the Internet traffic (including VOD service or T-commerce data), transferred to the set-top box, to the broadcasting signal frame processor 1803.

Typically, the Internet traffic is output to the PC. For the broadcasting data, only the channel requested by a set-top box is separated from the broadcasting data and transferred to the set-top box, so the broadcasting data are finally displayed on the TV.

The broadcasting signal frame processor 1803 has two functions classified according to the type of input traffic. One function is analyzing the type field of the Ethernet header and transferring only a broadcasting channel, requested by the set-top box, to the set-top box so as to provide a broadcasting TV service to the subscriber. The other is transferring the Internet traffic (VOD service or T-commerce data) other than broadcasting signals to the set-top box without a filtration step.

Apart from the function of filtering Ethernet broadcasting data, the Ethernet broadcasting frame detector 1801 has a function of storing an Ethernet MAC address allocated to the set-top box in a database, switching input unicast data having the Ethernet address of the set-top box together with the broadcasting traffic to the broadcasting signal frame processor 1803, and then transferring the unicast data and the broadcasting traffic to the set-top box.

As such, the broadcasting and communication combining system based on an Ethernet according to an embodiment of the present invention proposes a structure of providing both a wideband Internet service and a multi-channel digital broadcasting service using Ethernet broadcasting frames on a data communication network.

The subscriber network can be an EPON (Ethernet PON) network or a general Ethernet switching network. The EPON network is more adequate to the broadcasting service than the general Ethernet switching network, and the description is given primarily as to the EPON network. But, the embodiment of the present invention can also employ the general Ethernet switching network in the same manner as the EPON network.

Generally, the PON network comprises an OLT system that is a line terminal unit, and an ONU or ONT system that is a subscriber terminal unit. The EPON network also has an OLT system transferring downstream traffic to all the subscribers simultaneously via a passive optical divider, and an ONU or ONT system at the subscriber end selecting corresponding traffic.

Contrarily, the individual ONT systems divide the bandwidth through a method designated by the OLT system to transmit upstream traffic.

Unlike the method of providing a broadcasting service with a WDM overlay structure using at least two wavelengths as illustrated in FIG. 2, the embodiment of the present invention uses only one wavelength for EPON to provide an Internet service and a broadcasting service to subscribers.

To support both an Internet service and a broadcasting service with one wavelength, the broadcasting traffic is converted into Ethernet data and multiplexed, the multiplexed broadcasting traffic comprising the same band (one wavelength) of the Internet data.

The received data at the subscriber is classified into Internet traffic and broadcasting traffic, which are independently subjected to a separate processing step and sent to the final receiver.

While this invention has been described in connection with what is presently considered to be the most practical and preferred embodiment, it is to be understood that the invention is not limited to the disclosed embodiments, but, on the contrary, is intended to cover various modifications and equivalent arrangements included within the spirit and scope of the appended claims.

As described above, the broadcasting and communication combining system based on an Ethernet according to the present invention transmits data using Ethernet frames without a need for a separate wavelength for broadcast (broadcasting line) to maintain compatibility with a lowest-priced Ethernet transport network and to provide a combined service of broadcasting and communication in an economical way.

The broadcasting and communication combining system based on an Ethernet according to the present invention supports a digital broadcasting service on the existing CATV network without a need for replacement of a great deal of equipment in the CATV network interval.

The broadcasting and communication combining system based on an Ethernet according to the present invention supports the VOD broadcasting service as well as the cable broadcasting service, which has been separately provided, irrespective of the number of channels, and provides a broadcasting service by in-band multiplexing in the same manner as a general broadcasting service.

The broadcasting and communication combining system based on an Ethernet according to the present invention uses the header of Ethernet broadcasting frames to process broadcasting signals based on high-speed switching of layer 2, providing a high-speed broadcasting signal service.

Furthermore, the broadcasting and communication combining system based on an Ethernet according to the present invention enables higher-priority processing of broadcasting signals using Ethernet broadcasting frames to guarantee the QoS of the broadcasting signals using the MAC layer without a complicated protocol, and has almost all its functions simply realized in hardware without using a complex protocol, thereby simplifying control and operation procedures.

1. A broadcasting and communication combining system based on an Ethernet, which system is for providing an Internet traffic and broadcasting data service to a receiver of a subscriber network through a transmission network, the broadcasting and communication combining system comprising:
a broadcasting program provider for constructing Ethernet broadcasting frames from channel-specific broadcasting signals including a variable for determination of the type of broadcast and whether or not the signals are transferred, and sending the constructed Ethernet broadcasting frames; and
a system operator for receiving the Ethernet broadcasting frames from the broadcasting program provider, selecting one of the Ethernet broadcasting frames requested by each subscriber, reconstructing the selected Ethernet broadcasting frame, multiplexing the reconstructed Ethernet broadcasting frame together with the Internet traffic, and sending the multiplexed Ethernet broadcasting frame with the Internet traffic to the subscriber network.

2. The broadcasting and communication combining system as claimed in claim 1, wherein the transmission network comprises:
an edge switch for determining a priority of the Ethernet broadcasting frames and designating the Ethernet broadcasting frames as a virtual LAN (VLAN) group; and
a backbone switch for performing a tunneling function.

3. The broadcasting and communication combining system as claimed in claim 1 or 2, wherein when the broadcasting program provider provides a unidirectional CATV broadcasting service, the edge switch designates broadcasting contents provided from the broadcasting program provider to the system operator as one VLAN group and provides them to a plurality of the system operators, the system operator designating broadcasting contents provided through the edge switch as a second VLAN group or a specific Ethernet format and providing them to all the system operators.

4. The broadcasting and communication combining system as claimed in claim 1, wherein the subscriber network comprises:
a port for preliminarily allocating a bandwidth for broadcasting of as much as the number of broadcasting channels provided to the subscriber, and assigning the rest of the bandwidth as an Internet bandwidth for an Internet service.

5. The broadcasting and communication combining system as claimed in claim 1, wherein when the broadcasting signal is a digital broadcasting signal other than a broadcasting signal (MPEG-TS: MPEG transport stream) by MPEG-2 coding, the broadcasting program provider maps the broadcasting signal and converts it to a channel-specific Ethernet broadcasting frame.

6. The broadcasting and communication combining system as claimed in claim 1, wherein the broadcasting program provider comprises:
an encoder for converting a broadcasting stream to a broadcasting signal MPEG-TS when the broadcasting signal is analog;
a buffer for storing the converted MPEG-TS from the encoder and a broadcasting stream input in an MPEG-TS form; and
an Ethernet encapsulator for adding an Ethernet header for broadcast to the MPEG stream output from the buffer and sending the MPEG stream as an Ethernet broadcasting frame to the system operator.

7. The broadcasting and communication combining system as claimed in claim 6, wherein the Ethernet header for broadcast of the Ethernet encapsulator includes channel information and information indicating that the MPEG stream is broadcasting traffic.

8. The broadcasting and communication combining system as claimed in claim 6, wherein the Ethernet encapsulator transmits at least one MPEG-TS on one Ethernet broadcasting frame according to the number of the MPEG-TSs stored in the buffer.

9. The broadcasting and communication combining system as claimed in claim 8, wherein the Ethernet encapsulator determines the number of MPEG-TSs transferable on the Ethernet broadcasting frame by a maximum transmission unit provided in the transmission network.

10. The broadcasting and communication combining system as claimed in claim 1, wherein the channel-specific Ethernet broadcasting frame is constructed so as to carry broadcasting data on the Ethernet broadcasting frame, or to maintain a TCP/IP layer for a VOD (Video On Demand) broadcasting service or a bidirectional broadcasting service requested by the receiver of the subscriber.

11. The broadcasting and communication combining system as claimed in claim 1, wherein the Ethernet broadcasting frame comprises:
a destination address for making the Ethernet broadcasting frame arrive at the corresponding system operator from the broadcasting program provider;
a type field for designating an ID by the type of broadcast so as to discriminate the type of broadcast; and
a VLAN field for determining a priority of the broadcasting signals or constructing VLAN tunneling, and discriminating the broadcasting data.

12. The broadcasting and communication combining system as claimed in claim 11, wherein the destination address of the Ethernet broadcasting frame comprises a unicast or a multicast.

13. The broadcasting and communication combining system as claimed in claim 1, wherein the system operator comprises:
a distribution center for multiplexing all the Ethernet broadcasting frames received from the broadcasting program provider through a backbone network, or multiplexing only the Ethernet broadcasting frames requested by the subscriber network.

14. The broadcasting and communication combining system as claimed in claim 13, wherein the distribution center comprises:
a transmission block for adding a defined Ethernet header negotiated with the subscriber network to the broadcasting data in the form of the Ethernet broadcasting frame, or converting the broadcasting data in the form of the Ethernet broadcasting frame.

15. The broadcasting and communication combining system as claimed in claim 14, wherein the transmission block comprises:
a broadcast classification switch for analyzing the Ethernet broadcasting frame to determine the type of broadcast as a CATV broadcast, VOD broadcast, or Internet broadcast, and switching the Ethernet broadcasting frame to a corresponding channel by the respective broadcasting services;
a channel-specific Ethernet encapsulator for discriminating the classified Ethernet broadcasting frames of the broadcast classification switch according to the number of broadcasts and the broadcasting program provider, allocating broadcasting-service-specific channels to the Ethernet broadcasting frames, and adding an Ethernet header to the Ethernet broadcasting frames or converting the Ethernet broadcasting frames;
a multiplexer for multiplexing the broadcasting data Ethernet-header-added or converted by the Ethernet encapsulator; and
an Ethernet switch for switching and sending the multiplexed broadcasting data of the multiplexer together with the Internet traffic to each subscriber network.

16. The broadcasting and communication combining system as claimed in claim 15, wherein the channel-specific Ethernet encapsulator adds a factor to the Ethernet header, the factor being used for discriminating between the Internet traffic and the broadcasting data in the subscriber network.

17. The broadcasting and communication combining system as claimed in claim 16, wherein for providing a unidirectional broadcasting service such as CATV broadcast and Internet broadcast, the factor added to the Ethernet header includes a multicast address for discriminating the broadcasting signals, a VLAN field for allocating a priority of the broadcasting signals or constructing VLAN tunneling, and a type field for discriminating the type of the broadcasting signals and channels, the Ethernet broadcasting frame having a payload part thereof being constructed as an MPEG-TS.

18. The broadcasting and communication combining system as claimed in claim 16, wherein for providing a bidirectional broadcasting service such as VOD broadcast, the factor added to the Ethernet header includes a multicast address for discriminating the broadcasting signals, a VLAN field for allocating a priority of the broadcasting signals or constructing VLAN tunneling, and a type field for discriminating the type of the broadcasting signals and channels, the Ethernet broadcasting frame having a payload part thereof being constructed as an IP packet.

19. The broadcasting and communication combining system as claimed in claim 17 or 18, wherein the multicast address for the broadcasting data includes a specific address not used in common.

20. The broadcasting and communication combining system as claimed in claim 15, wherein the channel-specific Ethernet encapsulator adds a corresponding Ethernet header to the Ethernet broadcasting frames received in the form of the broadcasting signal (MPEG-TS), and converts the Ethernet broadcasting frames not received in the form of the broadcasting signal into an Ethernet header provided on the subscriber network.

21. The broadcasting and communication combining system as claimed in claim 1, wherein the receiver of the subscriber network comprises:
an Ethernet broadcasting frame detector for checking the received data from the system operator and discriminating between Internet traffic and broadcasting data;
a data frame processor for receiving the discriminated Internet traffic from the Ethernet broadcasting frame detector and sending it to a subscriber Internet service receiver; and
a broadcasting signal frame processor for receiving the discriminated broadcasting data from the Ethernet broadcasting frame detector and Internet traffic sent to a set-top box, and processing the broadcasting data and the Internet traffic to be displayed on a subscriber TV.

22. The broadcasting and communication combining system as claimed in claim 21, wherein the broadcasting signal frame processor provides the broadcasting data to the subscriber TV by sending only broadcasting channels of the broadcasting signals requested by the set-top box to the set-top box, and sends the Internet traffic other than the broadcasting signals to the set-top box.

23. The broadcasting and communication combining system as claimed in claim 21, wherein the Ethernet broadcasting frame detector filters the Ethernet broadcasting frame and sends the Internet traffic and the broadcasting data to the broadcasting signal frame processor, the Internet traffic including an Ethernet address assigned to the set-top box.

24. A broadcasting and communication combining method based on an Ethernet, which method is for providing an Internet traffic and broadcasting data service to a receiver of a subscriber network through a transmission network between a broadcasting program provider and a system operator, the broadcasting and communication combining method comprising:
(a) the broadcasting program provider constructing Ethernet broadcasting frames from channel-specific broadcasting signals including a variable for determination of the type of broadcast and whether or not the signals are transferred, and sending the constructed Ethernet broadcasting frames to the system operator through the transmission network;
(b) the system operator reconstructing the received Ethernet broadcasting frames of the step (a) by adding an Ethernet header used for determination of whether or not the broadcasting signals are transferred and discrimination between the Internet traffic and the broadcasting data; and
(c) the system operator selecting an Ethernet broadcasting frame requested by each subscriber among the reconstructed Ethernet broadcasting frames of the step (b), multiplexing the selected Ethernet broadcasting frame together with the Internet traffic, and sending the multiplexed Ethernet broadcasting frame with the Internet traffic to the subscriber network.

25. The broadcasting and communication combining method as claimed in claim 24, wherein the step (c) of receiving data by the subscriber network includes preliminarily allocating a broadcasting bandwidth of as much as the number of broadcasting channels provided to the subscriber, and assigning the rest of the bandwidth as an Internet bandwidth for an Internet service.

26. The broadcasting and communication combining method as claimed in claim 24, wherein the step (a) of constructing the Ethernet broadcasting frames includes:
(i) converting an analog broadcasting stream into a broadcasting signal (MPEG-TS), storing the converted broadcasting stream, and storing the broadcasting stream input in a MPEG-TS form without conversion;
(ii) adding a broadcasting Ethernet header to the MPEG-TS type broadcasting stream stored in the step (i) to construct an Ethernet broadcasting frame, and sending the constructed Ethernet broadcasting frame to the system operator.

27. The broadcasting and communication combining method as claimed in claim 26, wherein the step (ii) includes sending at least one MPEG-TS on one Ethernet broadcasting frame according to the number of the MPEG-TSs stored in the step (ii).

28. The broadcasting and communication combining method as claimed in claim 24, wherein the step (a) of constructing an Ethernet broadcasting frame includes constructing the Ethernet broadcasting frame so as to carry broadcasting data on the Ethernet broadcasting frame and to maintain a TCP/IP layer for bidirectional broadcasting data requested by the receiver of the subscriber.

29. The broadcasting and communication combining method as claimed in claim 24, wherein the step (a) of constructing an Ethernet broadcasting frame includes constructing the Ethernet broadcasting frame so as to include: a destination address for making the Ethernet broadcasting frame arrive at the corresponding system operator from the broadcasting program provider; a type field for discriminating the type of broadcast; and a VLAN field for determining a priority of the broadcasting signals or constructing VLAN tunneling, and discriminating the broadcasting data.

30. The broadcasting and communication combining method as claimed in claim 24, wherein the step (b) includes:
(i) analyzing the Ethernet broadcasting frame to determine the type of broadcast as a CATV broadcast, VOD broadcast, or Internet broadcast, and switching the Ethernet broadcasting frame to a corresponding channel by the respective broadcasting services;
(ii) discriminating the classified Ethernet broadcasting frames of the step (i) according to the number of broadcasts and a broadcasting program provider, allocating broadcasting-service-specific channels to the Ethernet broadcasting frames, and adding an Ethernet header to the Ethernet broadcasting frames or converting the Ethernet broadcasting frames; and
(iii) multiplexing the broadcasting data Ethernet-header-added or converted, and switching and sending the multiplexed broadcasting data together with the Internet traffic to each subscriber network.

31. The broadcasting and communication combining method as claimed in claim 30, wherein the Ethernet header of the step (ii) is for providing a unidirectional broadcasting service such as a CATV broadcast and Internet broadcast, the Ethernet header including a multicast address for discriminating the broadcasting signals, a VLAN field for allocating a priority of the broadcasting signals or constructing VLAN tunneling, and a type field for discriminating the type of the broadcasting signals and channels, the Ethernet broadcasting frame having a payload part thereof being constructed as an MPEG-TS.

32. The broadcasting and communication combining method as claimed in claim 30, wherein the Ethernet header of the step (ii) is for providing a bidirectional broadcasting service such as a VOD broadcast, the Ethernet header including a multicast address for discriminating the broadcasting signals, a VLAN field for allocating a priority of the broadcasting signals or constructing VLAN tunneling, and a type field for discriminating the type of the broadcasting signals and channels, the Ethernet broadcasting frame having a payload part thereof being constructed as an IP packet.

33. The broadcasting and communication combining method as claimed in claim 30, wherein the step (ii) includes:
adding a corresponding Ethernet header to the Ethernet broadcasting frames received in the form of the broadcasting signal (MPEG-TS); and
converting the Ethernet broadcasting frames not received in the form of the broadcasting signal into an Ethernet header provided on the subscriber network.

34. The broadcasting and communication combining method as claimed in claim 24, wherein the step (c) of the subscriber network receiving the Ethernet broadcasting frames includes:
(i) checking the received data from the system operator and discriminating between the Internet traffic and the broadcasting data and sending the Internet traffic to a subscriber Internet service receiver; and
(ii) outputting the broadcasting data among the discriminated data of the step (i) and Internet traffic transferred to a set-top box, to be displayed on a subscriber TV.
